(19) United States
(12) Patent Application Publication
(10) Pub. No.: US 2026/0242163 A1
(43) Pub. Date: Aug. 20, 2026

(54) VEHICLE RESTRAINT SYSTEM FOR A LOADING DOCK HAVING A DELAYABLE RELEASE SIGNAL

(71) Applicant: Blue Giant Equipment Corporation, Mississauga (CA)

(72) Inventors: Paulo Jorge da Silva Cruz, Vaughan (CA); Gerard Biasutto, Woodbridge (CA); Inderpreet Singh, Brampton (CA)

(73) Assignee: Blue Giant Equipment Corporation, Mississauga (CA)

(21) Appl. No.: 19/542,805

(22) Filed: Feb. 18, 2026

Related U.S. Application Data
(60) Provisional application No. 63/760,698, filed on Feb. 20, 2025.

(51) Int. Cl. B65G 69/00

(52) U.S. Cl. CPC B65G 69/003; B65G 2207/40

(57) ABSTRACT

A vehicle restraint includes a barricade member that operates to a blocking position to secure a vehicle relative to a facility. A locking member operates to a locking position that secures the barricade member in the blocking position. A motion sensor is coupled with the barricade member. An interior controller delivers an instruction to operate the actuator from the locking position to the release position when the locking member is in the locking position and the barricade member is in the blocking position. Where an excessive torque prevents operation of the locking member to the release position, the interior controller delivers the instruction to an instruction queue and activates an external alert proximate the vehicle. When the excessive torque is removed, the motion sensor senses a vibration, and the instruction in the instruction queue is delivered to the actuator to operate the locking member and the barricade member.

### CROSS-REFERENCE TO RELATED APPLICATION

This application claims priority to and the benefit under 35 U.S.C. § 119(e) of U.S. Provisional Patent Application No. 63/760,698, filed on Feb. 20, 2025, entitled VEHICLE RESTRAINT SYSTEM FOR A LOADING DOCK HAVING A DELAYABLE RELEASE SIGNAL, the entire disclosure of which is hereby incorporated herein by reference.

### FIELD OF THE DISCLOSURE

The present device is in the field of loading dock assemblies, and more specifically, a control system and apparatus for operating a vehicle restraint for a loading dock assembly that utilizes a digital sensing system and incorporates a delayed release signal for disengagement of the vehicle restraint.

### BACKGROUND OF THE DISCLOSURE

Loading dock assemblies within facilities include various components. These components can include, but are not limited to, vehicle restraints, dock doors, dock levelers, signaling systems, and other similar components. These components are typically operated according to a control panel that provides for operation of these components in a particular sequence and according to various protocols.

### SUMMARY OF THE DISCLOSURE

According to one aspect of the present disclosure, a vehicle restraint for a loading dock includes a barricade motor, an actuator, and a motion sensor. The barricade motor rotationally operates a barricade member between stored, blocking, and verification positions. The blocking position is configured to secure a vehicle relative to a loading dock assembly. The actuator rotationally operates a locking member between release and locking positions. The locking member in the locking position selectively engages the barricade member to secure the barricade member in the blocking position. A motion sensor is coupled with at least one of the barricade member, the locking member, the barricade motor, and the actuator. An interior controller is coupled with the actuator, the motion sensor and the barricade motor. The interior controller is adapted to deliver an instruction to operate the actuator from the locking position to the release position when the locking member is in the locking position and the barricade member is in the blocking position. In the event that an excessive torque exerted by the vehicle prevents operation of the locking member to the release position, the interior controller delivers the instruction to an instruction queue and activates an external alert proximate the vehicle. In the event that the excessive torque is subsequently removed, the motion sensor senses a vibration related to the release of the excessive torque, and the instruction in the instruction queue is delivered to the actuator. The interior controller verifies that the actuator has operated the locking member to the release position and the interior controller operates the barricade member to the stored position and deactivates the external alert.

According to another aspect of the present disclosure, a method for operating a vehicle restraint includes steps of operating a barricade member from a stored position to a blocking position, operating a locking member from a release position to a locking position to secure the barricade member in the blocking position that is configured to secure a vehicle in a parked position relative to a loading dock assembly, delivering an instruction to operate the locking member from the locking position to the release position to release the vehicle from the parked position, verifying that the locking member is moved away from the locking position, storing the instruction in an instruction queue in the event the locking member is prevented from moving away from the locking position by an interfering force, delivering an alert to an area proximate the vehicle to remove the interfering force, sensing vibrations indicative of the interfering force being removed from the locking member, delivering the instruction from the instruction queue to move the locking member to the release position, and moving the barricade member from the blocking position to the stored position.

According to yet another aspect of the present disclosure, a method for operating a vehicle restraint includes steps of operating a barricade member from a stored position toward a verification position to determine the presence and location of an impact guard of a vehicle relative to a loading dock assembly, operating the barricade member from the verification position to a proximal blocking position of a plurality of blocking positions, wherein the proximal blocking position locates the impact guard between the barricade member and the loading dock assembly, wherein an additional blocking position is not defined between the proximal blocking position and the impact guard, operating a locking member from a release position to a locking position to secure the barricade member in the proximal blocking position that is configured to secure the impact guard in a parked position relative to the loading dock assembly, delivering an instruction to operate the locking member from the locking position to the release position to release the impact guard from the parked position, verifying that the locking member is moved away from the locking position, storing the instruction in an instruction queue in the event the locking member is prevented from moving away from the locking position by an interfering force, delivering an alert to an area proximate the vehicle to remove the interfering force, sensing vibrations indicative of the interfering force being removed from the locking member, delivering the instruction from the instruction queue to move the locking member to the release position, and operating the barricade member from the proximal blocking position to the stored position.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic cross-sectional view of a loading dock assembly showing a vehicle restraint securing a vehicle in a parked position;

FIG. 2 is a schematic diagram illustrating a vehicle restraint having a plurality of blocking positions;

FIG. 3 is a schematic diagram of a vehicle restraint showing the barricade member in a stored position;

FIG. 4 is a schematic elevation view of an aspect of a vehicle restraint showing operation of the vehicle restraint from a lowered position to a raised position and with the barricade member moved to a verification position;

FIG. 5 is a side elevation view of a vehicle restraint showing the barricade member in a verification position to sense the position of a portion of the vehicle;

FIG. 6 is a cropped view of the vehicle restraint of FIG. 5, showing interior components of the vehicle restraint;

FIG. 7 is a cropped view of the vehicle restraint of FIG. 6 and showing the barricade member in a blocking position;

FIG. 8 is a cross-sectional view of the vehicle restraint of FIG. 7 and showing the barricade member in a first blocking position;

FIG. 9 is a cross-sectional view of the vehicle restraint of FIG. 8 and showing the barricade member in a second blocking position;

FIG. 10 is a cross-sectional view of the vehicle restraint of FIG. 5 and showing operational range of the barricade member;

FIG. 11 is a flow diagram illustrating operation of an engaging sequence of the barricade member between the stored position, the verification position, and a blocking position;

FIG. 12 is a flow diagram illustrating operation of a disengaging sequence that includes a delayed release sequence of the locking member and the barricade member;

FIG. 13 is a linear flow diagram illustrating a method for operating a vehicle restraint; and

FIG. 14 is a linear flow diagram illustrating a method for operating a vehicle restraint.

The components in the figures are not necessarily to scale, emphasis instead being placed upon illustrating the principles described herein.

### DETAILED DESCRIPTION

As required, detailed embodiments of the present disclosure are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

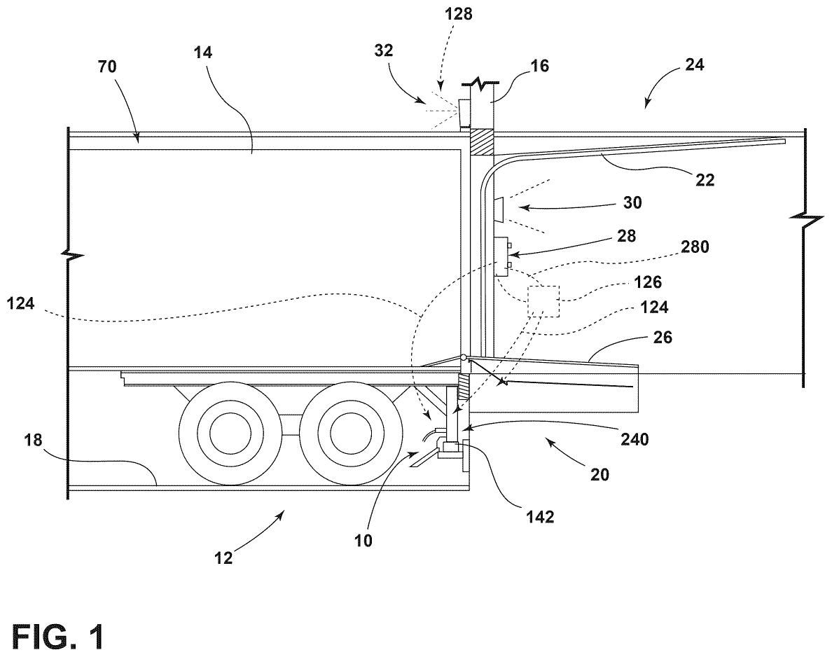

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle restraint system for a loading dock having a delayable release signal. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises. a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

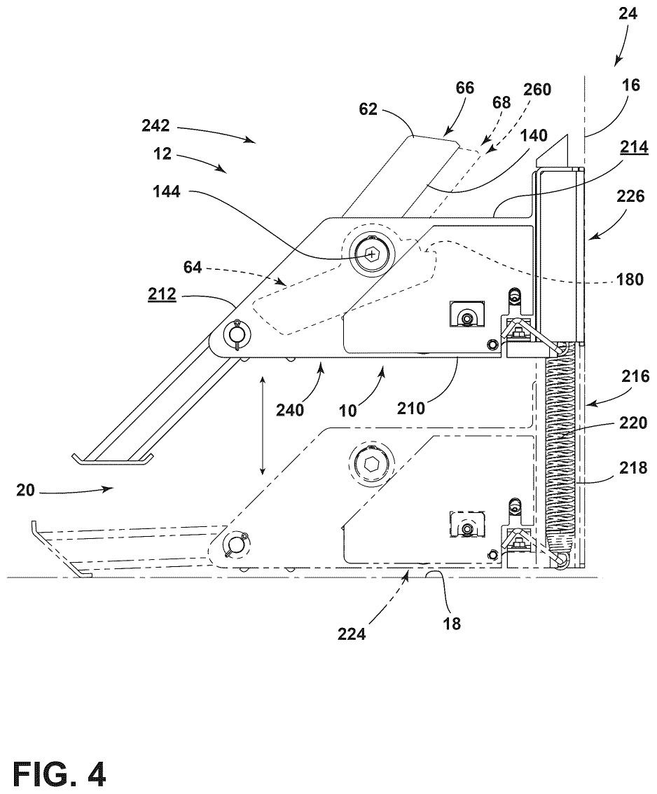

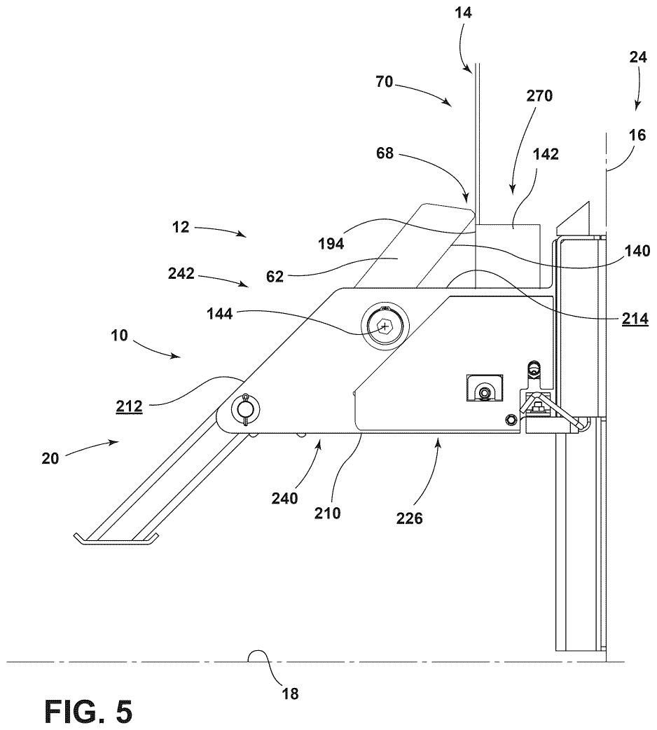

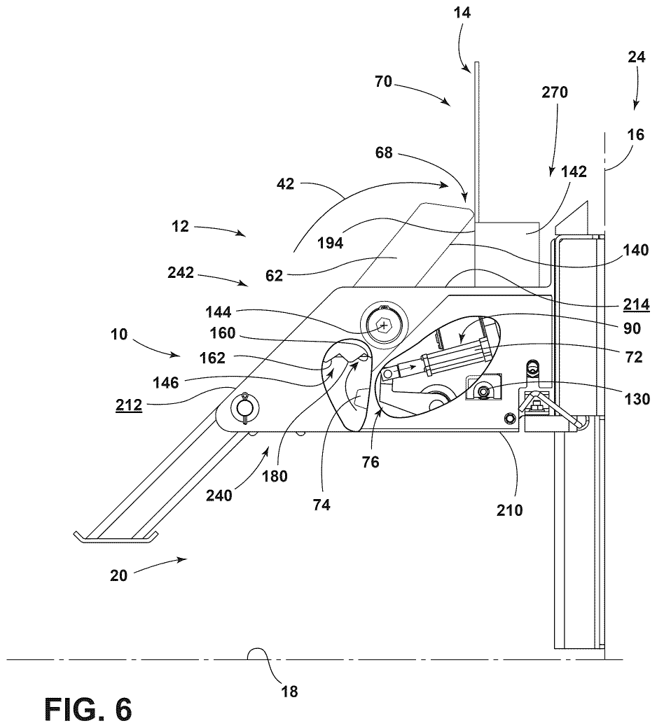

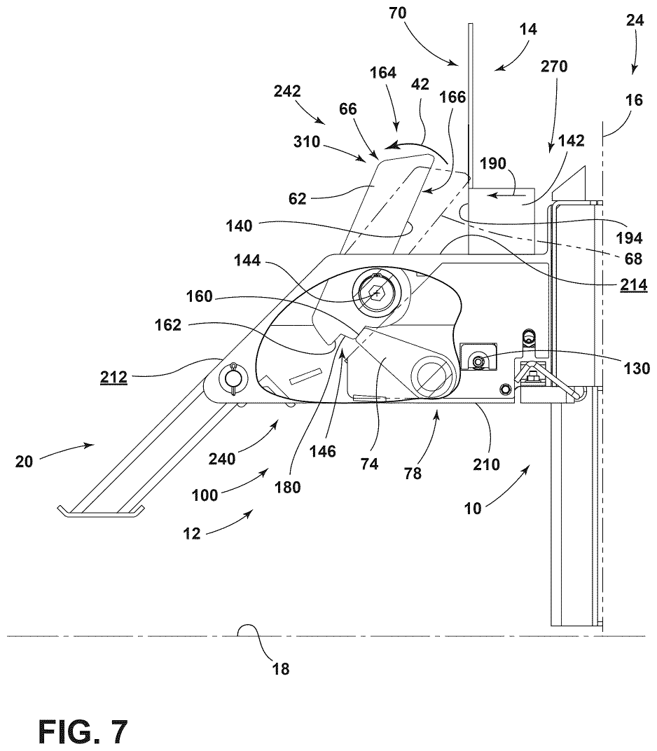

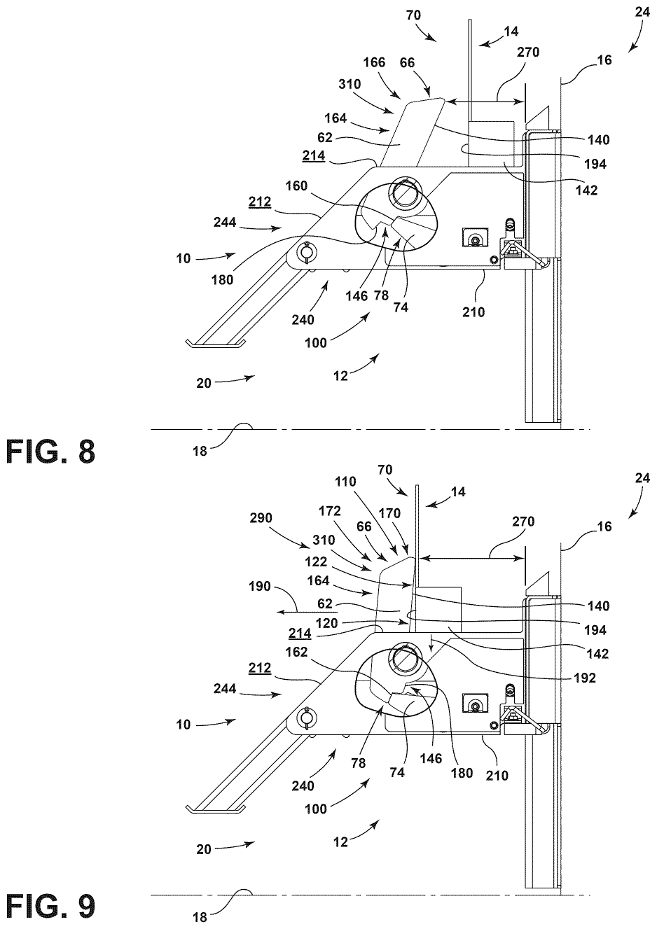

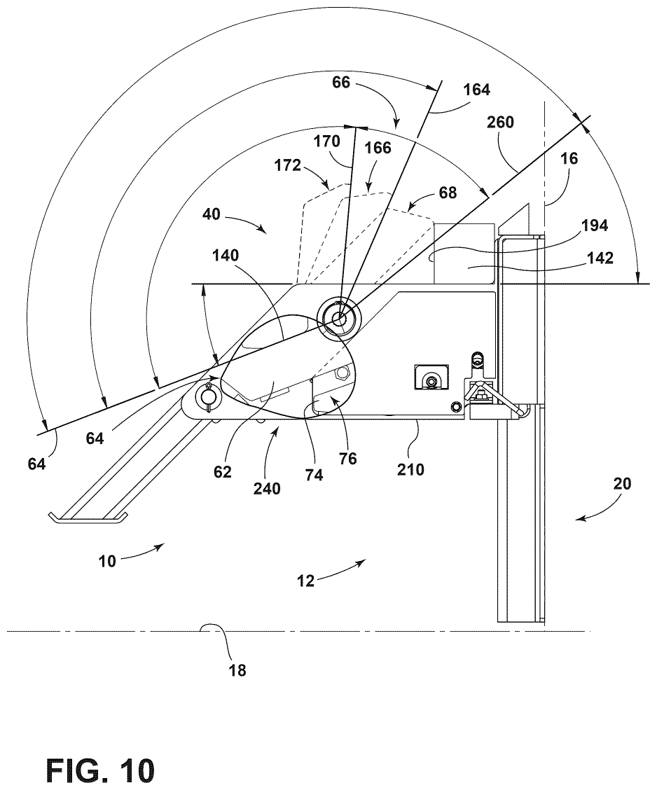

Referring to FIGS. 1-10, reference numeral 10 generally refers to a vehicle restraint that is utilized within a loading dock 12. The vehicle restraint 10 is utilized for restraining a vehicle 14 relative to a wall 16 for the loading dock 12 to prevent inadvertent or unwanted movement of the vehicle 14 away from the wall 16 of the loading dock 12. The vehicle restraint 10 is typically attached to a substrate 18, such as a concrete slab or pad, within a loading dock assembly 20. Additionally, the vehicle restraint 10 can be attached to the wall 16, such as a foundation wall or other structural wall 16 of a facility 24. The loading dock assembly 20 includes a door 22 for the loading dock 12 that provides access into the facility 24. The loading dock assembly 20 can also include a dock leveler 26 that extends from the loading dock 12 for the facility 24 into the vehicle 14 for accomplishing various loading and unloading operations. An interior controller 28 is provided within the facility 24 for providing a control interface of the loading dock assembly 20 from within the facility 24. Various interior signals 30 are positioned within the facility 24 and various exterior signals 32 are positioned outside of the loading facility 24 for communicating certain information to loading dock staff, the driver, and other individuals located within the facility 24 and outside the facility 24. Various controls can also be positioned outside of the facility 24 for allowing limited operation or full operation of components for the loading dock assembly 20 from outside of the facility 24.

Typically, for the safety of the personnel within and around the loading facility 24, control of the loading dock assembly 20 is provided through the interior controller 28. Through this configuration, limited interaction or no interaction is experienced between loading dock personnel, the vehicle 14, and the moving components of the loading dock assembly 20, such as the vehicle restraint 10, the dock leveler 26, the door 22, and other similar movable components of the loading dock assembly 20.

Referring again to FIGS. 1-10, the vehicle restraint 10 for the loading dock assembly 20 includes a barricade motor 60 that rotationally operates a barricade member 62 through and between a plurality of rotational positions 40. The operation of the barricade member 62 through the plurality of rotational positions 40 can include rotational operation 42 between the stored position 64, a blocking position 66, and a verification position 68. The blocking position 66 is configured to secure the vehicle 14 in a parked position 70 relative to the loading dock assembly 20. An actuator 72 selectively and rotationally operates a locking member 74 between a release position 76 and a locking position 78. The actuator 72 can be in the form of a linear actuator 90. In such an aspect of the device, linear operation of the linear actuator 90 can result in a rotational movement of the locking member 74 between the release position 76 and the locking position 78.

The locking member 74 in the locking position 78 selectively engages the barricade member 62 to secure the barricade member 62 in a blocking position 66. One or more motion sensors 80, such as a tilt sensor 82, are coupled with at least one of the barricade member 62, the locking member 74, the barricade motor 60, and the actuator 72. The interior controller 28 is coupled with the actuator 72, the motion sensor 80, and the barricade motor 60. The interior controller 28 is adapted to deliver one or more instructions 124 to selectively operate the actuator 72 from the locking position 78 to the release position 76. Movement of the locking member 74 to the release position 76 disengages the locking member 74 from the barricade member 62. Accordingly, in the release position 76, the barricade member 62 is able to be selectively operated between the plurality of rotational positions 40. This instruction 124 occurs when the loading or unloading operation is completed and the vehicle 14 in the parked position 70 at the loading dock assembly 20 is prepared to move away from the parked position 70.

Referring again to FIGS. 1-10, when the vehicle 14 is in the parked position 70 and before the vehicle 14 is released, the barricade member 62 is in the blocking position 66 and the locking member 74 is in the locking position 78. In this condition, both the barricade motor 60 and the actuator 72 are deenergized, deactivated, or otherwise placed in an idle state. Accordingly, the barricade member 62 and the locking member 74 are in a static condition 100 to maintain the barricade member 62 in the blocking position 66 and, in turn, maintain the vehicle 14 in the parked position 70.

Under certain conditions, an interfering force 120 can create an excessive torque condition 110. The excessive torque condition 110 can be characterized by the interfering force 120, such as an excessive torque 122, that is applied to the barricade member 62. The excessive torque 122 and other forms of the interfering force 120 can be exerted by the vehicle 14 onto the barricade member 62 and then transferred into the locking member 74 to create the excessive torque condition 110 that renders the locking member 74 unable to be moved away from the locking position 78. In the event that this interfering force 120 is exerted on the barricade member 62 to define the excessive torque condition 110, operation of the locking member 74 away from the locking position 78 and to the release position 76 can be prevented. In this excessive torque condition 110 when the interfering force 120 is present, an instruction 124 provided by the interior controller 28 is delivered first to the actuator 72 for moving the locking member 74 from the locking position 78 to the release position 76. When the motion sensor 80 verifies that no movement occurs within the locking member 74, or the barricade member 62, as a result of the instruction 124, the interior controller 28 delivers the instruction 124 to an instruction queue 126, such as a memory, of the loading dock assembly 20. This instruction 124 can be in the form of a signal that is stored digitally within the instruction queue 126. Contemporaneously, the interior controller 28 activates the exterior signal 32 that is positioned outside of the facility 24 and able to be viewed by loading dock personnel and/or the driver of the vehicle 14. The exterior signal 32 delivers an alert 128 that communicates information to the personnel outside the facility 24. The alert 128 indicates that the vehicle 14 is to be moved incrementally toward the wall 16 of the loading facility 24 to remove the excessive torque 122, or other interfering force 120, that is present within the interaction between the barricade member 62 and the locking member 74 and that is creating the excessive torque condition 110. After the excessive torque condition 110 is removed through movement of the vehicle 14 toward the wall 16 of the loading facility 24, the motion sensors 80 verify that the excessive torque 122 has been removed, as discussed below. After this verification, the instruction queue 126 delivers the instruction 124 to the actuator 72 and the locking member 74 is moved to the release position 76. The interior controller 28, using the motion sensor 80, verifies that the actuator 72 has operated to move the locking member 74 to the release position 76. The interior controller 28 then operates the barricade member 62 to the stored position 64 and deactivates the alert 128 of the exterior signal 32.

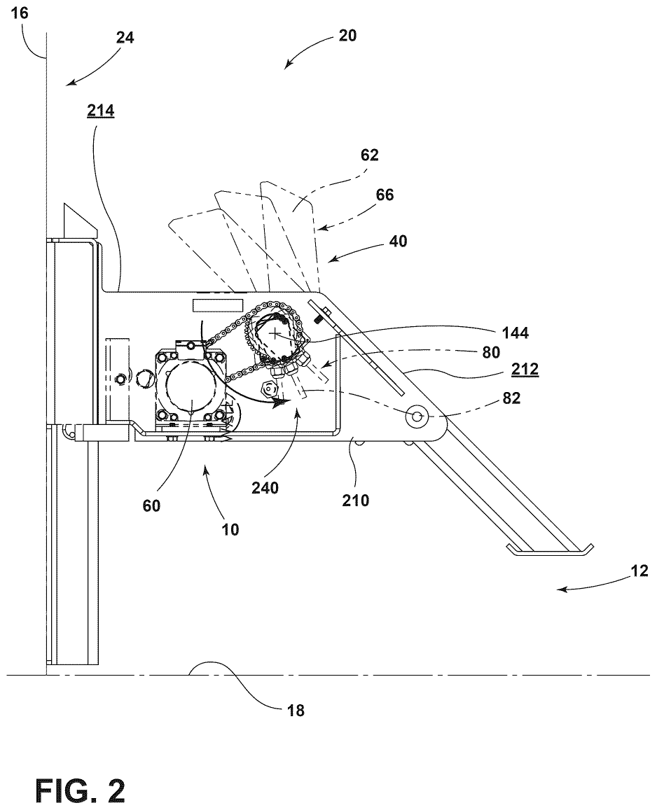

Referring again to FIGS. 2-10, the loading dock assembly 20 recognizes that the excessive torque 122 has been removed through use of the motion sensor 80, which can be in the form of a tilt sensor 82. When the excessive torque condition 110 is removed, certain vibrations or incremental movements typically occur within the barricade member 62 and/or the locking member 74. These vibrations, which are indicative of a removal of the excessive torque 122, are sensed by the motion sensor 80. When the vibration is recognized by the motion sensor 80, a signal is provided from the motion sensor 80 to the interior controller 28 confirming that a vibration was sensed. Once this vibration is sensed and the signal provided, the instruction 124 that is stored within the instruction queue 126 is then re-delivered to the actuator 72 for manipulating the locking member 74 from the locking position 78 to the release position 76. Where the interfering force 120 has been removed, the actuator 72 operates accordingly. Once the locking member 74 is in the release position 76, the barricade member 62 can be moved to the stored position 64. If the actuator 72 is still not able to be moved away from the locking position 78, the signal remains stored in the instruction queue 126 until such time as another vibration occurs and the instruction 124 is then re-delivered to the actuator 72, as discussed herein.

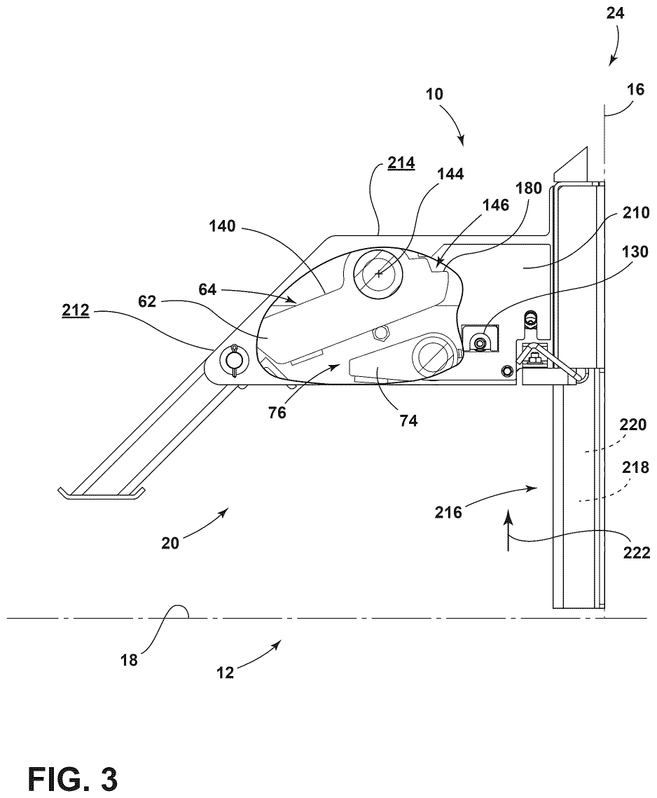

In certain aspects of the device, as exemplified in FIG. 3, where the interfering force 120 remains and motion of the locking member 74 is prevented, due to power failure or other conditions present with respect to the facility 24, the vehicle restraint 10 can include a manual release 130 that manually disengages the locking member 74 from the barricade member 62. Using the manual release, the locking member 74 may be moved laterally away from the barricade member 62, rather than rotationally. As described herein, the actuator 72 typically operates the locking member 74 in a rotational motion.

According to the various aspects of the device, the one or more motion sensors 80 can include any one of various sensors that can include, but are not limited to, the tilt sensor 82, level sensors, accelerometers, positions sensors, vibration sensors, and other similar sensors that detect rotational movement, vibrating movement, and other similar movements of the components of the vehicle restraint 10. As described herein, the motion sensor 80 is in communication with at least the actuator 72 and the locking member 74. The motion sensor 80 can also be in communication with the barricade member 62 and the barricade motor 60.

According to the various aspects of the device, the barricade member 62 can include a blocking surface 140 that is configured to engage a portion of the vehicle 14. The vehicle 14 typically includes a rear impact guard or “RIG” bar 142, sometimes referred to as an “ICC” bar, that forms a portion of the frame for the vehicle 14. This RIG bar 142 is sufficiently robust to interact with the barricade member 62, and to allow the barricade member 62 to restrain the vehicle 14 from moving away from the parked position 70 with respect to the loading facility 24. The blocking surface 140 extends outward from a barricade rotational axis 144 of the barricade member 62. On an opposing side of the barricade rotational axis 144 of the barricade member 62 is a plurality of locking surfaces 146 that interact with the locking member 74. These locking surfaces 146 define respective locking positions 78 of the barricade member 62.

As exemplified in FIGS. 2-10, the barricade member 62 includes a first locking surface 160 and a second locking surface 162. The first locking surface 160 corresponds to a first rotational angle 164 with respect to a wall 16 of the loading facility 24 that defines a first blocking position 166. The second locking surface 162 corresponds to a second rotational angle 170 with respect to a wall 16 of the loading facility 24 that corresponds to a second blocking position 172. The second rotational angle 170 is greater than the first rotational angle 164 such that two separate and distinct blocking positions 66 are able to be defined between the locking member 74 and the barricade member 62. It is contemplated that the barricade member 62 can include additional locking surfaces 146 that provide for additional blocking positions 66 of the barricade member 62. The various locking surfaces 146 of the barricade member 62 can be defined by a stepped surface 180 of the barricade member 62. This stepped surface 180 can define the plurality of locking surfaces 146 that engage the locking member 74 and, in turn, the plurality of corresponding blocking positions 66 of the barricade member 62.

According to the various aspects of the device, the blocking surface 140 of the barricade member 62, in any one of the plurality of blocking positions 66, is vertical or angled toward the wall 16 of the loading dock 12. Through this configuration, rearward movement 190 of the vehicle 14 away from the wall 16 of the loading facility 24 with the barricade member 62 in the blocking position 66 can be utilized to generate a generally downward force 192 between the blocking surface 140 of the barricade member 62 and a forward surface 194 of the RIG bar 142. This downward force 192 exerted on the RIG bar 142 further secures the vehicle 14 with respect to the vehicle restraint 10 and prevents motion of the vehicle 14 away from the loading dock assembly 20.

Referring again to FIGS. 2-10, the vehicle restraint 10 includes a housing 210 that at least partially surrounds the barricade motor 60, the locking member 74, and the actuator 72. The housing 210 also surrounds the barricade member 62, at least in the stored position 64. When the barricade member 62 moves to the verification position 68 and then into one of the blocking positions 66, the barricade member 62 extends outward from the housing 210 to engage the RIG bar 142 of the vehicle 14, or other surface of the vehicle 14 for securing the vehicle 14 in the parked position 70. The housing 210 includes a forward angled surface 212 that is configured to interact with the RIG bar 142 to vertically position the housing 210 and the remainder of the vehicle restraint 10 with respect to the RIG bar 142. Typically, the RIG bar 142 will rest upon a top surface 214 of the housing 210. To accomplish this configuration, the housing 210 includes a vertical operating mechanism 216, such as a track system 218 having a spring 220 or other biasing mechanism that biases the vehicle restraint 10 in an upward direction 222 from a lowered position 224 to a raised position 226 to engage the RIG bar 142 of the vehicle 14. The forward angled surface 212 of the housing 210 also serves to protect the interior components of the vehicle restraint 10. Accordingly, this forward angled surface 212 is typically reinforced to sustain impacts between the RIG bar 142 and the housing 210 for the vehicle restraint 10.

Referring again to FIGS. 1-10, the loading dock assembly 20 is critical for ensuring the safety and efficiency of loading and unloading operations with respect to the loading facility 24 and the vehicle 14. To ensure safety, reliable and accurate detection of a RIG bar 142 for a vehicle 14 and its position with respect to the loading facility 24 is desirable. In this manner, the vehicle restraint 10 described herein uses the motion sensors 80 for determining the position of the RIG bar 142 and for securing the vehicle 14 in the parked position 70 during these loading and unloading operations. A digital sensing system 240 described herein utilizes the motion sensor 80 and other various sensors, in combination with the locking member 74 and the barricade member 62, to make an engaging sequence 242 and a disengaging sequence 244 of the vehicle restraint 10 more accurate, repeatable, and reliable under a range of conditions. The motion sensors 80 also provide real-time feedback regarding the position of the RIG bar 142 with respect to the vehicle restraint 10 and the wall 16 of the loading dock assembly 20.

As exemplified in FIGS. 1-10, the digital sensing system 240 described herein combines the physical trailer-holding mechanism, in the form of the vehicle restraint 10, with an intelligent control and sensing unit that incorporates the motion sensor 80, the interior controller 28, the interior signals 30, and the exterior signals 32 that are installed within and around the loading dock assembly 20 and the facility 24. The digital sensing system 240, as described herein, evaluates the position, alignment, and configuration of the RIG bar 142 to determine whether the RIG bar 142 is positioned within an acceptable securing range 270. The digital sensing system 240 automates the engaging sequence 242 and the disengaging sequence 244 of the vehicle restraint 10 for ensuring precise operation of the vehicle restraint 10. The digital sensing system 240 also provides feedback to loading dock personnel via various signals that can include alarms, lights, and other messages and indices. Using the digital sensing system 240, the RIG bar 142 can be secured where the RIG bar 142 is damaged, deformed, covered in debris, or otherwise in an atypical configuration.

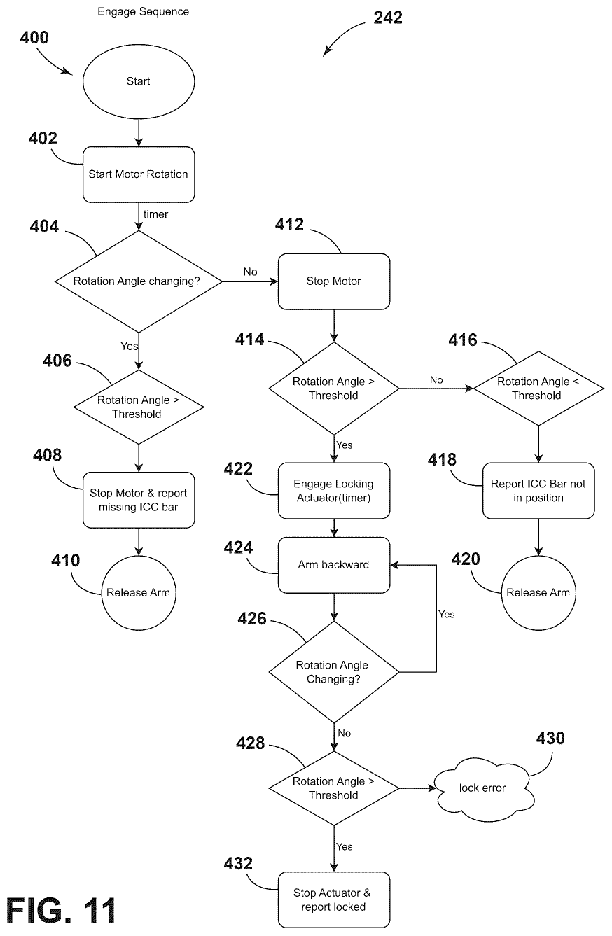

Referring now to FIGS. 1-11, having described various aspects of the vehicle restraint 10 and the digital sensing system 240, a method 400 illustrates the engaging sequence 242 of the vehicle restraint 10 when a vehicle 14 is moved into the parked position 70. According to the method 400, the barricade motor 60 is rotated from the stored position 64 toward the verification position 68 (step 402). The motion sensor 80 confirms that the barricade member 62 has left the stored position 64 and is moving toward the verification position 68 (step 404). In this verification step 404, motion of the barricade member 62 rotates to sense a position of the RIG bar 142 within a desired range. In certain conditions, the barricade member 62 rotates to an outer verification position 260 (step 406). This outer verification position 260 is indicative of the ICC bar 142 not being present within the desired range, or not within a securing range 270 of the vehicle restraint 10 (step 408). In this condition, the barricade motor 60 returns the barricade member 62 to the stored position 64 (step 410). The motion sensor 80 assists the vehicle restraint 10 in sensing the position of the RIG bar 142.

Referring again to FIGS. 1-11, when the barricade member 62 moving to the verification position 68 engages the RIG bar 142, the motion sensor 80 senses a vibration in the form of the barricade member 62 engaging an obstruction, typically the RIG bar 142 or other portion of the vehicle 14. The motion sensor 80 also has certain stored rotational positions that are indicative of the stored position 64, the outer verification position 260, and the various blocking positions 66, as described herein. These vibrations and other movements of the components of the vehicle restraint 10 can be sensed due to a change in the angular position of the motion sensor 80, typically a tilt sensor. Accordingly, the motion sensor 80 is configured to sense minute changes in the angular position of these components, typically, the barricade member 62. Where a vibration is sensed between the stored position 64 and the outer verification position 260, this is indicative of the RIG bar 142 being present within a securing range 270 relative to the vehicle restraint 10. Conversely, where the barricade member 62 rotates to the outer verification position 260 without interruption, the motion sensor 80 recognizes the outer verification position 260 as being a stored rotational position of the barricade member 62. Accordingly, the motion sensor 80 determines the absence of the RIG bar 142 and communicates with the interior controller 28 that the RIG bar 142 is not in position. The barricade member 62 is then returned to the stored position 64.

Referring again to FIGS. 1-11, where the barricade member 62 engages the RIG bar 142 short of the outer verification position 260, the motion sensor 80 recognizes the impact through a vibration, or sudden stopping force. The motion sensor 80 sends a signal to the interior controller 28 or directly to the barricade motor 60 to stop rotation of the barricade member 62 (step 412). The rotational angle of the barricade member 62 is then determined in relation to the blocking positions 66 (step 414). Another verification step can occur where the motion sensor 80 determines whether the position of the RIG bar 142 is appropriate for properly securing the vehicle 14. In situations where the barricade member 62 is engaged with the RIG bar 142 and is at a rotational angle of greater than 90° with respect to the wall 16 of the loading facility 24, the RIG bar 142 may not be able to be secured in this position (step 416). In this situation, the interior controller 28, in cooperation with the motion sensor 80 and the barricade motor 60, provides instruction that the RIG bar 142 is not in an appropriate position (step 418). The barricade member 62 is then returned to the stored position (step 420).

Referring again to FIGS. 1-11, where the barricade member 62 engages the RIG bar 142 within a securing range 270 relative to the vehicle restraint 10, the interior controller 28 begins a locking sequence (step 422). The barricade member 62 is then moved away from the RIG bar 142 toward the nearest blocking position 66 of the vehicle restraint 10 (step 424). The motion sensor 80 confirms that this rotation occurs (step 426). This confirmation can be used to determine whether an obstruction is preventing movement of the barricade member 62 toward the nearest blocking position 66. The motion sensor 80 determines that the barricade member 62 is in the appropriate blocking position 66 (step 428). Where the motion sensor 80 cannot confirm that the barricade member 62 is in the appropriate blocking position 66, an error signal can be delivered from the interior controller 28 to the components of loading dock assembly 20 to return the barricade member 62 into engagement with the RIG bar 142 to reconfirm the position of the RIG bar 142 with respect to the securing range 270 (step 430). Once the barricade member 62 is in the blocking position 66 and the locking member 74 is moved from the release position 76 to the locking position 78, the barricade motor 60 and the actuator 72 for the locking member 74 are each de-energized and the static condition 100 of the vehicle restraint 10 is defined (step 432).

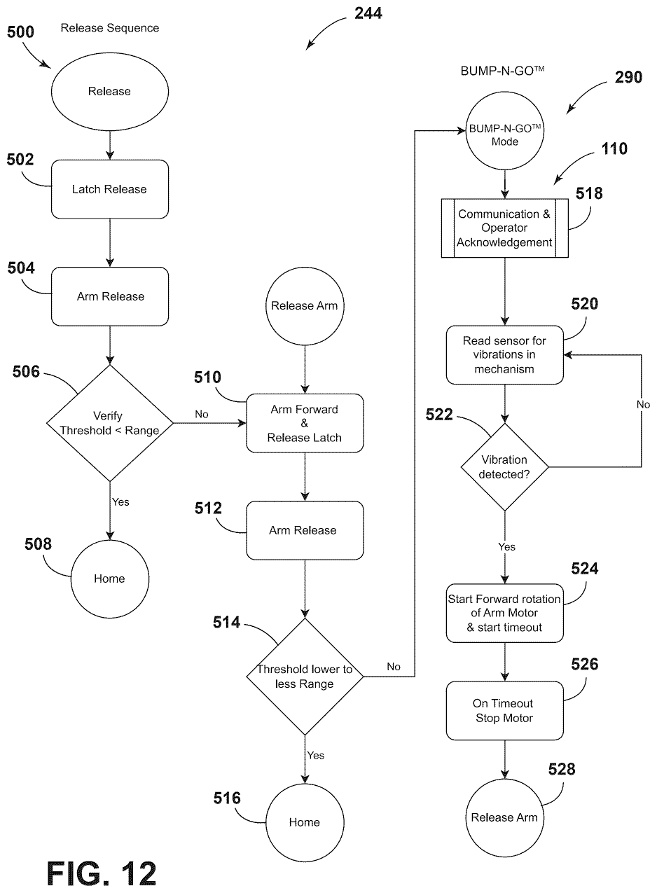

Referring now to FIGS. 1-10 and 12, having described various aspects of the loading dock assembly 20 as well as the engaging sequence 242, a method 500 includes a disengaging sequence 244 of the barricade member 62 and the locking member 74. According to the method 500, a step 502 includes providing an instruction 124 from the interior controller 28 to release the locking member 74 from the locking position 78 to the release position 76. This instruction 124 operates the actuator 72 to move the locking member 74 (step 504). The motion sensor 80 verifies that the locking member 74 is rotating from the locking position 78 to the release position 76 (step 506). In this manner, the motion sensor 80 can be attached to the locking member 74 itself, or to the actuator 72. Under typical operating circumstances, the locking member 74 moves to the release position 76 and the barricade member 62 is then moved to the stored position 64 (step 508).

Referring again to FIGS. 1-10 and 12, under certain conditions, an interfering force 120, such as an excessive torque 122, may be defined between the barricade member 62 and locking member 74. When this excessive torque 122 is present, a large amount of friction exists between the locking member 74 and the barricade member 62. In this condition, this excessive torque 122 prevents operation of the locking member 74 away from locking position 78. Accordingly, the motion sensor 80, sensing no movement, communicates the lack of motion of the locking member 74 or the actuator 72 away from the locking position 78 to the interior controller 28. As described herein, in this situation, the instruction 124 to the actuator 72 to move the locking member 74 is stored in the instruction queue 126 for later delivery. Contemporaneously, subsequently, or alternatively, a separate instruction 280 is provided to the barricade motor 60 to rotate the barricade member 62 toward the RIG bar 142 (step 510). In certain conditions, motion of the barricade motor 60 toward the RIG bar 142 can alleviate the excessive torque 122. The motion sensor 80 can sense this motion of the barricade member 62 toward the RIG bar 142 and a signal is provided to the interior controller 28 (step 512). When the barricade member 62 is moved toward the RIG bar 142 and is out of engagement with the locking member 74, the instruction 124 is provided from the instruction queue 126 to the actuator 72 for moving the locking member 74 toward the release position 76 (step 514). When the locking member 74 is moved to the release position 76, the barricade member 62 can then be moved to the stored position 64 (step 516).

Referring again to FIGS. 1-10 and 12, in certain conditions, the RIG bar 142 can be engaged with the barricade member 62 and may be actively exerting the excessive torque 122 against the barricade member 62, and, in turn, against the locking member 74. In this condition, the stored signal within the instruction queue 126 for moving the actuator 72 remains stored within the instruction queue 126. Additionally, the separate instruction 280 to the barricade motor 60 to move the barricade member 62 toward the RIG bar 142 is also stored in the instruction queue 126. Contemporaneously, a signal is provided to an exterior signal 32 in the form of the alert 128. This external alert 128 communicates to the loading dock personnel outside of the facility 24 that the excessive torque 122 is present between the barricade member 62 and locking member 74. This alert 128 to the outside personnel indicates that the vehicle 14 needs to be moved toward the wall 16 of the loading facility 24. This motion of the vehicle 14 will provide clearance for the barricade member 62 to rotate away from the locking member 74 to alleviate the excessive torque 122. (step 518). When the vehicle 14 is moved away from engagement with the barricade member 62, the motion sensor 80 senses a corresponding vibration or other motion of the vehicle restraint 10. This event results in a signal being delivered to the interior controller 28 that the instruction 124 to the locking member 74, the separate instruction 280 to the barricade motor 60, or both, can now be delivered and carried out (step 520). The interior controller 28, during this torque release sequence 290, awaits the signal from the motion sensor 80 that vibrations have been detected (step 522). Once the vibration is detected, the instruction 124 and/or the separate instruction 280 are delivered and the locking member 74 and/or barricade member 62, respectively, are rotated. In the case of the locking member 74, rotation is toward the release position 76. In the case of the barricade member, the rotation is toward the RIG bar 142, which has been moved toward the wall 16 of the loading facility 24 (step 524). If needed, the instruction 124 to the actuator 72 is then delivered to move the locking member 74 to the release position 76 (step 526). Once the locking member 74 is moved to the release position 76, the barricade member 62 can be moved to the stored position 64 (step 528).

Referring again to FIGS. 1-12, the various sensors utilized within the loading dock assembly 20 continuously track the position of the barricade member 62 as well as the engagement status of the locking member 74, whether in the locking position 78 or the release position 76. Use of the sensors track and record the incremental rotation values as well as data collected by the motion sensors 80. This data can include accelerometer data and dynamic positional tracking. These data points are gathered by the various motion sensors 80 for delivery to the interior controller 28. The interior controller 28 can then provide real-time instructions 124 to the various components of the loading dock assembly 20 as well as real-time communications to the various personnel positioned within the facility 24 and outside the facility 24 via the interior signal 30 and the exterior signal 32.

Referring again to FIGS. 1-12, the motion sensors 80 in combination with the interior controller 28, as described herein, provides real-time data regarding the movements of the barricade member 62 between the stored position 64, the verification position 68, and the one or more blocking positions 66. Various vibrations or sudden stops that are experienced by the barricade member 62 are sensed by the motion sensors 80 and communicated to the interior controller 28. The rotational positions of these events are evaluated by the interior controller 28 to confirm that the RIG bar 142 is within an appropriate securing range 270 with respect to the vehicle restraint 10. The interior controller 28, using the motion sensors 80, also confirm that the barricade member 62 is within an appropriate rotational position for securing the RIG bar 142 in the parked position 70. The motion sensors 80 also confirm that the locking member 74 is within a locking position 78 for securing the barricade member 62 within an appropriate blocking position 66 of the various blocking positions 66. Using the motion sensors 80, very discrete and accurate measurements and data points can be taken with respect to the barricade member 62 and interactions with the locking member 74, and various obstructions that include the RIG bar 142 of the vehicle 14. Using real-time data capture and communication to the interior controller 28, instructions 124 provided to the components of the vehicle restraint 10 and signals communicated to the personnel within the facility 24 and personnel outside the facility 24 can occur contemporaneously and in real time. These timely communications assist in ensuring the safety of these interior personnel and exterior personnel during operation of the loading dock assembly 20.

It is contemplated that various confirmation interactions can occur with respect to the personnel within the facility 24 and outside the facility 24. These confirmation interactions can be used as a secondary safety measure to confirm that personnel are positioned at a safe zone with respect to the vehicle 14, the facility 24, and the loading dock assembly 20.

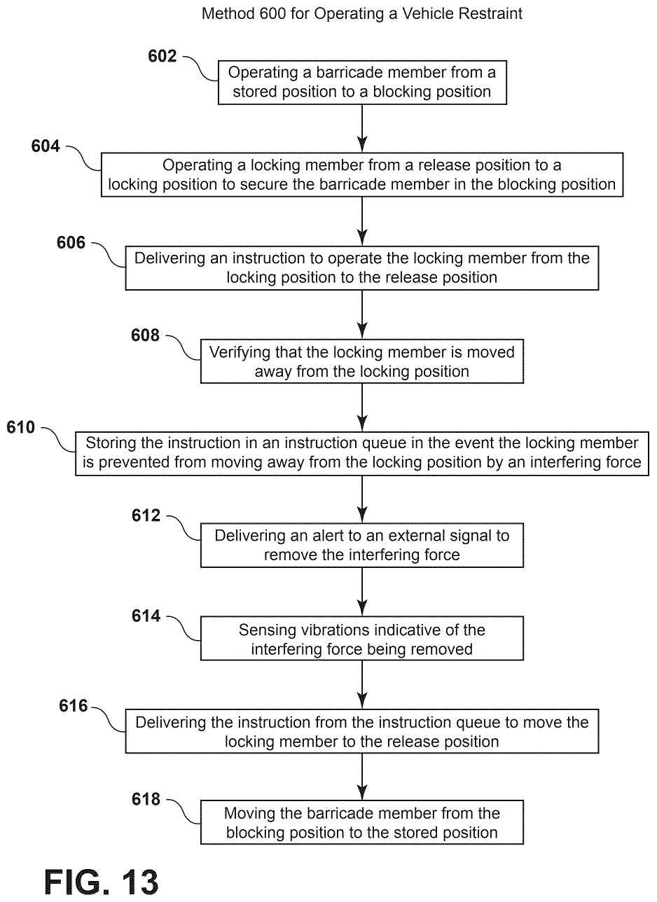

Referring again to FIGS. 1-10 and 13, a method 600 is disclosed for operating a vehicle restraint 10. According to the method 600, a step 602 includes operating the barricade member 62 from the stored position 64 to the blocking position 66. The locking member 74 is then operated from a release position 76 to a locking position 78 to secure the barricade member 62 in the blocking position 66 (step 604). This blocking position 66 is configured to secure the vehicle 14 in a parked position 70 relative to the loading dock assembly 20. Once a loading or unloading operation is complete, an instruction 124 is delivered to operate the locking member 74 from the locking position 78 to the release position 76 (step 606). This instruction 124 is intended to release the vehicle 14 from the parked position 70. Using the various sensors, these sensors verify that the locking member 74 has moved away from locking position 78 (step 608). Where the locking member 74 has not moved away from locking position 78, the instruction 124 is stored in the instruction queue 126 (step 610). As described herein, this instruction 124 is provided when the locking member 74 is prevented from moving away from the locking position 78 by an interfering force 120, such as the excessive torque 122, as described herein. A signal is also delivered to an area proximate the vehicle 14 to remove the interfering force 120 (step 612). As described herein, this interfering force 120 can typically be removed through operation of the vehicle 14 toward the wall 16 of loading facility 24, thereby removing excessive torque 122 (step 612). The various motion sensors 80 sense vibrations within the barricade member 62, the barricade motor 60, the locking member 74, and/or the actuator 72 that are indicative of the interfering force 120 being removed from the locking member 74 (step 614). The instructions 124 are then delivered from the instruction queue 126 to the actuator 72 to move the locking member 74 to the release position 76 (step 616). The barricade member 62 can then be moved to the stored position 64 (step 618).

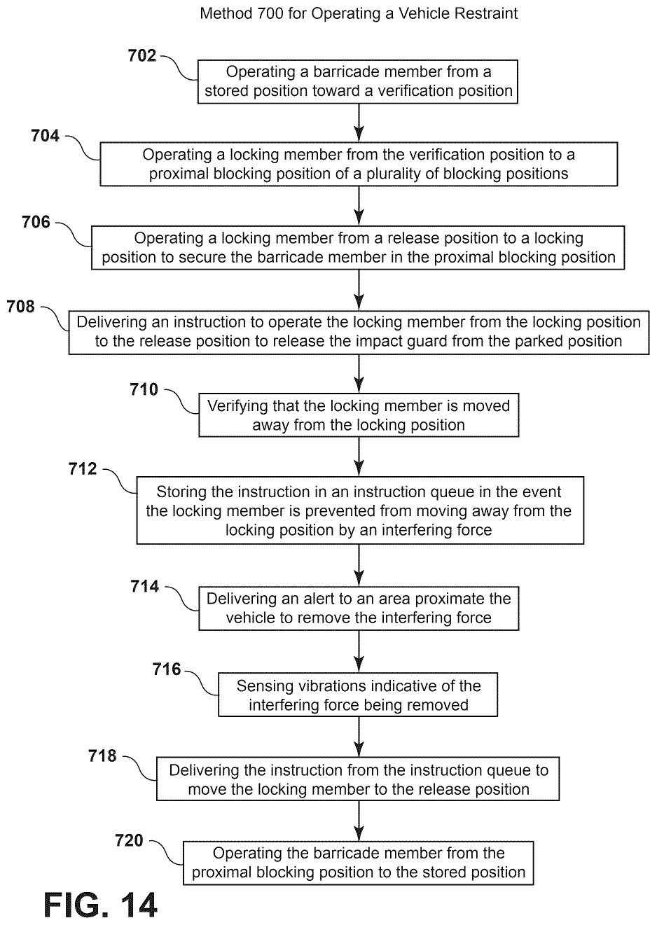

According to the various aspects of the device, as exemplified in FIGS. 1-10 and 14, a method 700 is disclosed for operating a vehicle restraint 10. According to this method 700, step 702 includes operating a barricade member 62 from the stored position 64 toward a verification position 68 to determine the presence and location of the RIG bar 142 of a vehicle 14 relative to the loading dock assembly 20. The barricade member 62 is then operated from the verification position 68 to a proximal blocking position 310 of a plurality of blocking positions 66 (step 704). The proximal blocking position 310 locates the RIG bar 142 between the barricade member 62 and the loading dock assembly 20. Also, an additional blocking position 66 of the plurality of blocking positions 66 is not defined between the proximal blocking position 310 and the RIG bar 142. Accordingly, the barricade member 62 is located in the nearest blocking position 66 that can be utilized to secure the RIG bar 142 in the parked position 70. The locking member 74 is then operated from the release position 76 to the locking position 78 to secure the barricade member 62 in the proximal blocking position 310 (step 706). Once in the locking position 78, the locking member 74 and the barricade member 62 secure the RIG bar 142 relative to the loading dock assembly 20 in the parked position 70. As described herein, in the parked position 70, the actuator 72 and the barricade motor 60 are deenergized such that the barricade member 62 and the locking member 74 are in a static condition to secure the vehicle 14 in the parked position 70. Once a loading and unloading operation is complete, an instruction 124 is delivered to operate the locking member 74 from the locking position 78 to the release position 76 to release the RIG bar 142 from the parked position 70 (step 708). The various motion sensors 80 verify the locking member 74 is moved away from the locking position 78 (step 710). Where the locking member 74 has not moved away from the locking position 78, the instruction 124 is stored in an instruction queue 126 (step 712). As described herein, the locking member 74 can be prevented from moving away from the locking position 78 by an interfering force 120, such as the excessive torque 122. An alert 128 is then delivered to an area proximate the vehicle 14 to remove the interfering force 120 (step 714). In certain conditions, motion of the vehicle 14 toward the wall 16 of loading facility 24 is sufficient to remove the excessive torque 122 or other interfering force 120. The various motion sensors 80 sense vibrations within the loading dock assembly 20 that are indicative of the interfering force 120 being removed from the locking member 74 (step 716). The instruction 124 is then delivered from the instruction queue 126 to the actuator 72 to move the locking member 74 to the release position 76 (step 718). The barricade member 62 is then operated from the proximal blocking position 310 to the stored position 64 (step 720).

According to the various aspects of the device, the digital sensing system 240 incorporated within the vehicle restraint 10 provides accurate and real-time instructions to the components of the loading dock assembly 20 as well as timely alerts 128 and other communications to the various personnel within the facility 24 and outside the facility 24 near the vehicle 14. Utilizing the digital sensing system 240, additional safety measures can be provided when the vehicle 14 cannot be released from the parked position 70 using the typical operating processes of the loading dock assembly 20. The digital sensing system 240 utilizes various sensors to sense vibrations and other movements within the loading dock assembly 20 to determine whether the components are able to move to the respective positions to allow for a release of the vehicle 14 away from the parked position 70. This motion is accomplished while maintaining a safe working environment within the facility 24 and outside the facility 24.

It will be understood by one having ordinary skill in the art that construction of the described disclosure and other components is not limited to any specific material. Other exemplary embodiments of the disclosure disclosed herein may be formed from a wide variety of materials, unless described otherwise herein.

What is claimed is:

1. A vehicle restraint for a loading dock, the vehicle restraint comprising:
a barricade member that is selectively operable between a plurality of rotational positions that includes a blocking position configured to secure a vehicle relative to a loading dock assembly;
a locking member that is selectively operable to a locking position that secures the barricade member in the blocking position; and
a motion sensor coupled with at least one of the barricade member and the locking member; wherein
an interior controller is coupled with an actuator of the locking member, the motion sensor, and a barricade motor of the barricade member, the interior controller adapted to deliver an instruction to operate the actuator from the locking position to a release position when the locking member is in the locking position and the barricade member is in the blocking position;
in the event that the barricade member is in an excessive torque condition of the plurality of rotational positions that prevents operation of the locking member to the release position, the interior controller activates an external alert proximate the vehicle; and
in the event that the barricade member is released from the excessive torque condition, the instruction is delivered to the actuator.

2. The vehicle restraint of claim 1, wherein after the barricade member is released from the excessive torque condition, the interior controller verifies that the actuator has operated the locking member to the release position and the interior controller operates the barricade member to a stored position and deactivates the external alert.

3. The vehicle restraint of claim 1, wherein the release of the barricade member from the excessive torque condition is sensed through a vibration within at least one of the barricade member and the locking member.

4. The vehicle restraint of claim 1, wherein the plurality of rotational positions of the barricade member includes a stored position and a verification position, wherein the blocking position is defined between the stored position and the verification position.

5. The vehicle restraint of claim 1, wherein the release position disengages the locking member from the barricade member.

6. The vehicle restraint of claim 1, wherein the barricade member includes a plurality of blocking positions.

7. The vehicle restraint of claim 6, wherein the plurality of blocking positions are defined within a stepped surface of the barricade member, wherein engagement between the locking member and a portion of the stepped surface selectively defines each blocking position of the plurality of blocking positions.

8. The vehicle restraint of claim 1, wherein, when the barricade member is in the blocking position, the barricade motor is deactivated.

9. The vehicle restraint of claim 3, wherein the motion sensor is coupled with the barricade member, and wherein the release of the barricade member from the excessive torque condition results in the vibration of the barricade member that is sensed by the motion sensor.

10. The vehicle restraint of claim 1, wherein the actuator for the locking member is a linear actuator.

11. The vehicle restraint of claim 10, wherein linear operation of the linear actuator results in a rotational movement of the locking member between the locking position and the release position.

12. The vehicle restraint of claim 1, wherein the release of the barricade member from the excessive torque condition is defined by operation of the vehicle away from the barricade member and toward a wall of the loading dock assembly.

13. The vehicle restraint of claim 1, wherein the excessive torque condition is characterized by an excessive torque placed upon the barricade member by the vehicle.

14. A method for operating a vehicle restraint, the method comprising steps of:
operating a barricade member from a stored position to a blocking position;
operating a locking member from a release position to a locking position to secure the barricade member in the blocking position that is configured to secure a vehicle in a parked position relative to a loading dock assembly;
delivering an instruction to operate the locking member from the locking position to the release position to release the vehicle from the parked position;
verifying that the locking member is moved away from the locking position;
storing the instruction in an instruction queue in the event the verification step confirms that the locking member is prevented from moving away from the locking position by an interfering force;
delivering an alert to an area proximate the vehicle to remove the interfering force;
confirming that the interfering force is removed from the locking member;
delivering the instruction from the instruction queue to move the locking member to the release position;
moving the locking member to the release position; and
moving the barricade member from the blocking position to the stored position.

15. The method of claim 14, wherein the step of confirming that the interfering force is removed includes sensing vibrations indicative of the interfering force being removed from the locking member.

16. The method of claim 14, wherein the interfering force includes an excessive torque applied to the barricade member, wherein the excessive torque is at least partially transferred to the locking member, and wherein the excessive torque is removed by moving the vehicle away from the barricade member and toward a wall of the loading dock assembly.

17. The method of claim 14, wherein the step of delivering the instruction from the instruction queue to move the locking member to the release position includes verifying that the locking member has been moved from the locking position to the release position.

18. A method for operating a vehicle restraint, the method comprising steps of:
operating a barricade member from a stored position toward a verification position to determine the presence and location of an impact guard of a vehicle relative to a loading dock assembly;
operating the barricade member from the verification position to a proximal blocking position of a plurality of blocking positions, wherein the proximal blocking position locates the impact guard between the barricade member and the loading dock assembly, wherein an additional blocking position is not defined between the proximal blocking position and the impact guard;
operating a locking member from a release position to a locking position to secure the barricade member in the proximal blocking position that is configured to secure the impact guard in a parked position relative to the loading dock assembly;
delivering an instruction to operate the locking member from the locking position to the release position to release the impact guard from the parked position;
verifying that the locking member is moved away from the locking position;
storing the instruction in an instruction queue in the event the locking member is prevented from moving away from the locking position by an interfering force;
delivering an alert to an area proximate the vehicle to remove the interfering force;
confirming that the interfering force is removed from the locking member;
delivering the instruction from the instruction queue to move the locking member to the release position; and
operating the barricade member from the proximal blocking position to the stored position.

19. The method of claim 18, wherein the step of confirming that the interfering force is removed includes sensing vibrations indicative of the interfering force being removed.

20. The method of claim 18, wherein the interfering force includes an excessive torque applied to the barricade member, wherein the excessive torque is at least partially transferred to the locking member, and wherein the excessive torque is removed by moving the vehicle away from the barricade member and toward a wall of the loading dock assembly.
